(19) United States
(12) Patent Application Publication
(10) Pub. No.: US 2016/0037523 A1
(43) Pub. Date: Feb. 4, 2016

(54) CARRIER ALLOCATION

(71) Applicants: Na WEI, Beijing (CN); Lili ZHANG, Beijing (CN); Wei BAI, Beijing (CN); Chunyan GAO, Beijing (CN); Pengfei SUN, Beijing (CN); Jing HAN, Beijing (CN); Haiming WANG, Beijing (CN); Wei HONG, Beijing (CN)

(72) Inventors: Na WEI, Beijing (CN); Lili ZHANG, Beijing (CN); Wei BAI, Beijing (CN); Chunyan GAO, Beijing (CN); Pengfei SUN, Beijing (CN); Jing HAN, Beijing (CN); Haiming WANG, Beijing (CN); Wei HONG, Beijing (CN)

(21) Appl. No.: 14/782,189

(22) PCT Filed: Apr. 3, 2013
(86) PCT No.: PCT/CN2013/073753

§ 371 Date: Oct. 2, 2015

(51) Int. Cl. H04W 72/04; H04W 72/08

(52) U.S. Cl. CPC H04W 72/0453; H04W 72/082

(57) ABSTRACT

The present invention relates to methods, apparatuses and a computer program product for carrier allocation. The invention includes defining change occasion for a base station for changing a component carrier. The invention further includes receiving, at a processor, from a first base station, information regarding carrier interference severeness between the first base station and a second base station, wherein the carrier interference severeness comprises at least one of an expected separately usable protected carrier number, the number of user equipments located in a common coverage area of the first and second base station, and the downlink traffic load related to the user equipments, and allocating carrier pattern for the first base station based on the received information. Further, the invention includes composing, by a part of a first base station, a report including information regarding carrier interference severeness between the first base station and a second base station, wherein the carrier interference severeness comprises at least one of an expected separately usable protected carrier number, the number of user equipments located in a common coverage area of the first and second base station, and the downlink traffic load related to the user equipment, and causing transmission of the report to an allocating unit.

### FIELD OF THE INVENTION

The present invention relates to carrier allocation, and more particularly, relates to methods, apparatuses and a computer program product for carrier allocation.

### BACKGROUND

The main ideas of operation carrier selection (OCS) are captured in the following text described in document [1] (with more details in document [2]):
“3gpp has discussed solutions for operational carrier selection (OCS) by a pico which is located within a macro cell coverage (DL CB-ICIC in case of frequency reuse in dense macro-pico heterogeneous deployment). The scenario envisaged is where the pico is able to dynamically (e.g. minutes, hours) activate/deactivate a carrier so that the interference on the neighbour cells is acceptable. When discussing the problem, 3gpp considered an option that an eNB which is about to activate a carrier bases such decision on the feedback received via X2 from cells potentially affected by the activation. The feedback can be based, e.g., on measurements collected from served UEs by the potential victim eNBs.”

The OCS scheme provides an additional mechanism to perform interference management between eNBs in a HetNet environment on a carrier resolution. Several studies in RAN1 have already confirmed benefits of resource partitioning between eNBs, so it makes good sense to also explore the carrier dimension for this purpose. One advantage of performing resource partitioning in the carrier-domain is that it offers protection for both data and control channels.

As further background information, the relevance of CB-ICIC and OCS can be summarized as:
CB-ICIC offers resource partitioning between base station nodes on carrier resolution.
CB-ICIC can work also for networks without strict time synchronization.
CB-ICIC works for all UE categories. Does not require new UE support.
CB-ICIC can be used as a technique for inter-eNB coordinated optimization of CA usage.
CB-ICIC can be standardized with only minor updates of X2 specifications (cf. document [4]), i.e. without impact on physical layer, no additional eNB-2-UE signaling.

Recently, the small cell enhancement is proposed in document [3] as a study item. It is identified that small cell enhancement should consider sparse and dense small cell deployments. In some scenarios (e.g., hotspot indoor/outdoor places, etc.), single or a few small cell node(s) are sparsely deployed, e.g. to cover the traffic hotspot(s). Meanwhile, in some scenarios (e.g., dense urban, large shopping mall, etc.), a lot of small cell nodes are densely deployed to support huge traffic over a relatively wide area covered by the small cell nodes. Furthermore, smooth future extension/scalability (e.g.: from sparse to dense, from small-area dense to large-area dense, or from normal-dense to super-dense) should be considered. For throughput performance, dense deployments should be prioritized compared to sparse deployments.

Small cell enhancement should also take into account the possibility for frequency bands that, at least locally, are only used for small cell deployments. Co-channel deployment scenarios between macro layer and small cell layer should be considered as well.

Some example spectrum configurations are:
1. Carrier aggregation on the macro layer with bands X and Y, and only band X on the small cell layer
2. Small cells supporting carrier aggregation bands that are co-channel with the macro layer
3. Small cells supporting carrier aggregation bands that are not co-channel with the macro layer

However, in the scenario of a dense deployment with multiple femto cells having common coverage and interfering each other severely, the above mentioned approach considered currently on OCS cannot address the carrier allocation effectively.

Moreover, also in the scenario of a dense deployment with one macro plus multiple pico cells and pico cells having common coverage and interfering each other severely, the above mentioned approach considered currently on OCS can not address the carrier allocation effectively.

Furthermore, it is pointed out in document [3] that for interfaces between macro and small cell, as well as between small cells, the studies should first identify which kind of information is needed or beneficial to be exchanged between nodes in order to get the desired improvements before the actual type of interface is determined. And if direct interface should be assumed between macro and small cell, as well as between small cell and small cell, X2 interface can be used as a starting point.

The present application will give some considerations on the insufficiency of current OCS solution, and furthermore propose the appropriate enhancement to ensure the correct operation of OCS solution when multiple small cells are interfering each other severely.

### REFERENCES

[1]: R3-121458, “LS on operation carrier selection for CB-ICIC”, 3GPP TSG-RAN3 Meeting #76, Prague, Czech Republic, 21-25 May 2012;
[2]: TR 03.024, V0.3.0, May 2012, 3GPP, “Carrier-based HetNet ICIC use cases and solutions”;
[3]: 3GPP specification TR 36.932;
[4]: 3GPP specification TS 36.423;
[5]: “Autonomous Component Carrie Selection: Interference Management in Local Area Environments for LTE-Advanced”, Femtocell wireless communications, IEEE Communications Magazine, September 2009.

### SUMMARY OF THE INVENTION

According to exemplary aspects of the present invention, there are provided methods, apparatuses and a computer program product for autonomous carrier allocation change occasion of carrier aggregation based inter-cell interference coordination.

Various aspects of exemplary embodiments of the present invention are set out in the appended claims.

According to an exemplary aspect of the present invention, there is provided a method comprising defining change occasion for a base station for changing a component carrier.

According to another exemplary aspect of the present invention, there is provided a method comprising:
receiving, at a processor, from a first base station, information regarding carrier interference severeness between the first base station and a second base station,
wherein the carrier interference severeness comprises at least one of an expected separately usable protected carrier number, the number of user equipments located in a common coverage area of the first and second base station, and the downlink traffic load related to the user equipments, and
allocating carrier pattern for the first base station based on the received information.

According to another exemplary aspect of the present invention, there is provided a method comprising:
composing, by a part of a first base station, a report including information regarding carrier interference severeness between the first base station and a second base station,
wherein the carrier interference severeness comprises at least one of an expected separately usable protected carrier number, the number of user equipments located in a common coverage area of the first and second base station, and the downlink traffic load related to the user equipment, and
causing transmission of the report to an allocating unit.

According to another exemplary aspect of the present invention, there is provided an apparatus comprising:
at least one processor,
and at least one memory including computer program code,
the at least one memory and the computer program code arranged to, with the at least one processor, cause the apparatus at least to perform:
defining change occasion for a base station for changing a component carrier.

According to another exemplary aspect of the present invention, there is provided an apparatus comprising:
at least one processor,
and at least one memory including computer program code,
the at least one memory and the computer program code arranged to, with the at least one processor, cause the apparatus at least to perform:
receiving, from a first base station, information regarding carrier interference severeness between the first base station and a second base station,
wherein the carrier interference severeness comprises at least one of an expected separately usable protected carrier number, the number of user equipments located in a common coverage area of the first and second base station, and the downlink traffic load related to the user equipments, and
allocating carrier pattern for the first base station based on the received information.

According to another exemplary aspect of the present invention, there is provided an apparatus for use in a first base station, comprising:
at least one processor,
and at least one memory including computer program code,
the at least one memory and the computer program code arranged to, with the at least one processor, cause the apparatus at least to perform:
composing a report including information regarding carrier interference severeness between the first base station and a second base station,
wherein the carrier interference severeness comprises at least one of an expected separately usable protected carrier number, the number of user equipments located in a common coverage area of the first and second base station, and the downlink traffic load related to the user equipment, and
causing transmission of the report to an allocating unit.

According to another exemplary aspect of the present invention, there is provided an apparatus comprising:
means for defining change occasion for a base station for changing a component carrier.

According to another exemplary aspect of the present invention, there is provided an apparatus comprising:
means for receiving, from a first base station, information regarding carrier interference severeness between the first base station and a second base station,
wherein the carrier interference severeness comprises at least one of an expected separately usable protected carrier number, the number of user equipments located in a common coverage area of the first and second base station, and the downlink traffic load related to the user equipments, and
means for allocating carrier pattern for the first base station based on the received information.

According to another exemplary aspect of the present invention, there is provided an apparatus for use in a first base station, comprising:
means for composing a report including information regarding carrier interference severeness between the first base station and a second base station,
wherein the carrier interference severeness comprises at least one of an expected separately usable protected carrier number, the number of user equipments located in a common coverage area of the first and second base station, and the downlink traffic load related to the user equipment, and
means for causing transmission of the report to an allocating unit.

According to an exemplary aspect of the present invention, there is provided a computer program product comprising computer-executable computer program code which, when the program is run on a computer (e.g. a computer of an apparatus according to any one of the aforementioned apparatus-related exemplary aspects of the present invention), is arranged to cause the computer to carry out the method according to any one of the aforementioned method-related exemplary aspects of the present invention.

Such computer program product may comprise or be embodied as a (tangible) computer-readable (storage) medium or the like on which the computer-executable computer program code is stored, and/or the program may be directly loadable into an internal memory of the computer or a processor thereof.

Advantageous further developments or modifications of the aforementioned exemplary aspects of the present invention are set out in the dependent claims.

### BRIEF DESCRIPTION OF THE DRAWINGS

For a more complete understanding of exemplary embodiments of the present invention, reference is now made to the following description taken in connection with the accompanying drawings in which:

FIG. 1 is a diagram illustrating an example of change occasions according to certain aspects of the first embodiment of the present invention;

FIG. 2 is a diagram illustrating another example of change occasions according to certain aspects of the first embodiment of the present invention;

FIG. 3 is a flowchart illustrating an example of a method according to certain aspects of the first embodiment of the present invention;

FIG. 4 is a block diagram illustrating an example of an apparatus according to certain aspects of the first embodiment of the present invention;

FIG. 5 is a flowchart illustrating an example of a method according to certain aspects of the second embodiment of the present invention;

FIG. 6 is a flowchart illustrating another example of a method according to certain aspects of the second embodiment of the present invention;

FIG. 7 is a block diagram illustrating an example of an apparatus according to certain aspects of the second embodiment of the present invention.

### DESCRIPTION OF EXEMPLARY EMBODIMENTS

Exemplary aspects of the present invention will be described herein below. More specifically, exemplary aspects of the present are described hereinafter with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, a LTE/LTE-Advanced communication system is used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

The present invention generally relates to carrier change for small cell base stations, e.g. small cell eNBs.

Basically, there can be distinguished between a case where there is communication available between the various eNBs (e.g. via X2 interface) and a case where there is no or only limited communication available between the eNBs (e.g. for eNBs without X2 interface).

Among cell which need ICIC, an X2 interface is not always available. For example, for operator deployed macro/pico cells the x2 interface is normally there. However, for femto cells which are deployed in each home, the X2 interface is usually not available.

Thus, in some embodiments of the invention, the case in which no or only limited communication is available between the eNBs will be described with references to femto cells, and the case in which communication is available via the X2 interface will be described with references to pico cells.

For example, in overlapping macro/pico and pico/pico interference scenarios, as described below in detail, the X2 interface can be utilized for information exchange among eNBs to make a good choice on carrier allocation.

However, the femto cells may not have X2 interfaces, and cannot use those proposals. The autonomous carrier allocation is addressed and evaluated in document [5]. In this document, the algorithm for carrier selection is explained in details. However, document [5] assumes ideal information exchange and detailed procedure in more realistic situation is not addressed and some open issues still require further investigation.

### First Embodiment

### Scenario without X2 Interfaces

The first embodiment of the present invention is about scenarios without X2 interfaces. For example, the first embodiment relates to a femto type cell which do not have X2 link, but only have over air communication capabilities to communicate with other femto or Macro cells (low overhead, much less frequent, not reliable, half blind on carrier coordination), or even do not have any inter-cell communication link at all (totally blind coordination). In such case, the change of carrier is up to the femto cell itself. There could be high chance that multiple cells are changing their carrier configurations simultaneously, and change may results into further chaos since the change is totally uncoordinated.

On the other hand, there are only little possibilities in case there is no or little communication among the cells. Some measures are needed to prevent such change carrier chaos from happening.

Besides, in case that at least little communication can be enabled among cells, there is a need for inter-cell messages to support such autonomous carrier selection. One critical thing here is the low payload. For example, Over-the-air (OTA) communication among cells, or UE assisted forwarding may potentially be used.

In both cases the payload will be very limited. In document [5], it is assumed that the allocation of primary component carrier (PCC) and secondary component carriers (SCCs) is signaled among eNBs (either over the backhaul or over the air) periodically and/or whenever the allocation is changed, so eNBs know which component carriers neighboring eNBs are currently using and choose another. However, such assumption maybe not always true. This limitation is also explicitly mentioned in the following passage in document [5].
“After the new eNB has selected its PCC, the cell is configured, and it is ready to transmit and carry traffic. In parallel, the eNB shall constantly monitor the quality of the PCC to make sure that it continues to have the desired quality and coverage. If poor quality is detected, recovery actions will be triggered to improve the situation. Such actions can be understood as additional defensive measures, not allowing potentially erroneous PCC/SCC allocations to catastrophically interfere with neighboring base stations.”

As discussed, such issue is likely to happen in reality, and therefore more investigation is needed in this aspect, and some embodiments of the invention seek a solution for this question.

Thus, according to certain aspects of the first embodiment of the present invention, it is proposed how to proceed to solve the CC collision and identify the optimal CC with the least performance degradation, with collision/strong interference in CC selection.

According to certain aspects of the first embodiment of the present invention, for a stable autonomous carrier selection for the case that X2 backhaul is not available, it is proposed to define change time occasion in which the carrier change can be made.

Moreover, the occasion can be further linked to physical cell identifier (PCI) and may be linked also to load status. Besides, for a case that limited over air inter-cell communication is available, a new exchange message to assist efficient CC selection collision is proposed.

In the following, some aspects of the first embodiment of the present invention will be described in more detail.

According such aspects, the basic idea is about how to define change occasions for different uncoordinated cells (e.g. femto cells), so that when one cell makes a certain change, the other cells will be stable.

Thus, according to certain aspects, the following is proposed:
Certain cell change occasion (CO), including periodicity, start offset, allowed carrier change (1 CC at a time, or more), etc. are predefined, and/or linked to PCI, and/or configured by Macro eNB or other controller.
Within each CO, only a subset is PCO (Pcell change occasion), and only a subset or all CO are SCO (Scell change occasion).
The change occasion may be defined to include a cell state change occasion relating to change of the cell state from an active state to a dormant state or from a dormant state to an active state.
Define different offset in time for different femto cells to avoid that multiple cells change simultaneously, and the offset can be linked to PCI.
cell can make Scell change on SCO, Pcell change on PCO. In other time, the cell is not allowed for carrier change.
The interval for CO can further be linked to serving load, e.g., when the load is low, the CO interval can be the basic interval predefined, and the higher the load, the smaller CO interval can be used, such as, for example, ½ of basic interval.

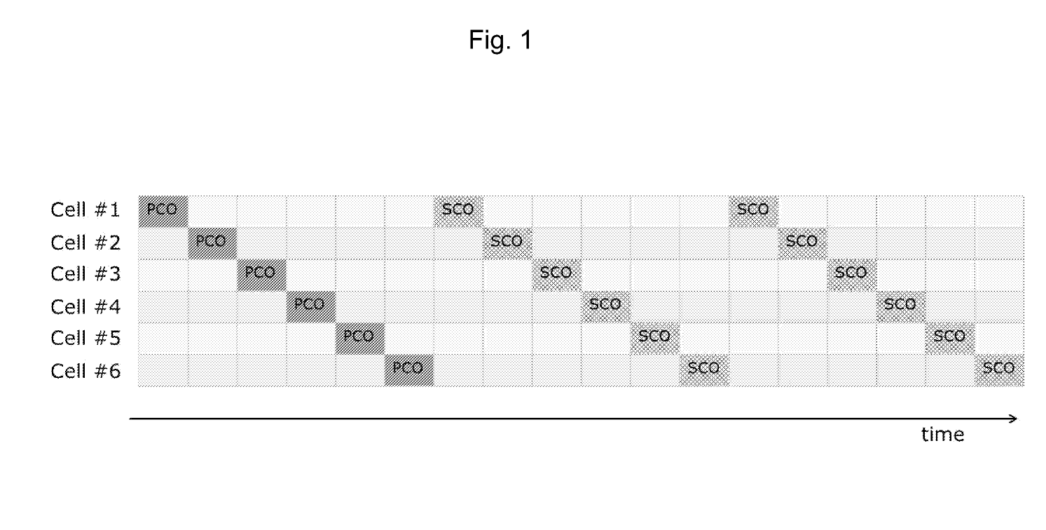

One example implementation for certain aspects of the first embodiment is illustrated in FIG. 1. In this example, the different cells #1 to #6 have orthogonal COs and the Cos are linked to their respective PCI, so this CO can be implicitly known without any inter-cell communication.

In the example shown in FIG. 1, there are three COs for each cell, and among these COs, ⅓ thereof could be defined for PCO, and ⅔ thereof could be defined for SCO.

In case one cell (e.g. femto cell) detects neighour femto's PCI (e.g. by network listening), it can have better anticipation on when certain neighour might change the carrier, and a certain order can be brought into such a non-coordination scenario.

It is noted that certain femto cells may or may not change in the CO, depending on its needs.

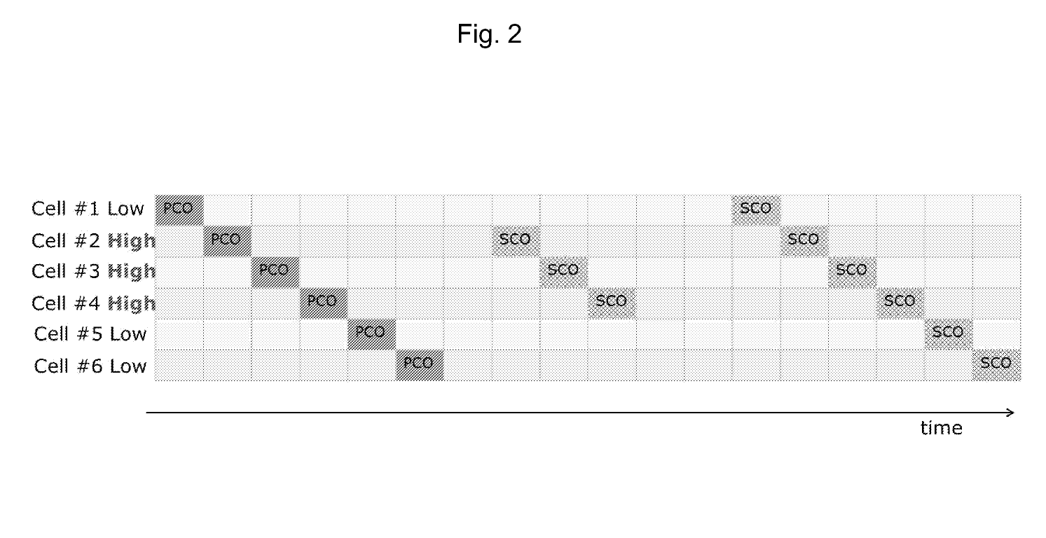

Further, FIG. 2 shows an example implementation in which the load is taken into account, i.e. shows an option of introduction of load related interval adjustment.

For example for cells #2 to #4, since there is a high load, the interval for CO is reduced by half in comparison to the interval of the cells with low load, and hence, more change opportunities are available for the cells with high load. The high or low (or more load levels) can be predefined.

The proposed solution according to some embodiments of the present invention enables the following advantages for autonomous carrier change without X2 interface.

For example, the carrier adjustment chaos by the introduced CO approach can be eliminated. Further, an effective recovery action can be enabled by the introduced signaling message.

As described above in detail, certain aspects of the first embodiment relate to a scenario without any communication among cells, not even air communication interface. In such a case, each cell (e.g. femto cell) works on its own measurement, and makes decision, without relying on obtaining and informing functions.

Thus, in some instances, it may be an advantage that there is no pre-requirement on inter-cell air communication (or X2) at all.

In some embodiments, the change occasion is a very short period inside a big cycle, as shown in FIGS. 1 and 2, so that there is a large period when no cell can make any change.

In some embodiments, it is a further advantage that most of the time the interference situation among cells is stable, and the cell can have enough time to make accurate measurements on interference when no cell makes any change. Since there is no signaling in between, the measurement is the only source for the cell to understand the neighour interference situation. And the above described proposal makes it easier to identify its major interference cell.

In some embodiments, Pcell occasion and Scell occasion are proposed separately, and it is proposed that the occasion subframe is linked to PCI implicitly, so no communication is needed among cells.

In some embodiments, it is an advantage that with PCI linkage, the cell, when measuring the strongest interference, can implicitly understand the PCI that the interfering cell is using, and understand next possible change occasions of its interfering cells, and can make measurement or change carrier accordingly. This can reduce blind change among cells, and avoid change carrier in a chaos, for this scenario in which no signaling is possible.

The interval for CO can further be linked to serving load, e.g., when the load is low, the CO interval can be the basic interval predefined, and the higher the load, the smaller CO interval can be used, such as equally ½ of basic interval.

In some embodiments, it is an advantage that this enables more occasions for a high load cell. Further, this can enable some implicit understanding of neighour cell's load situation in addition to PCI.

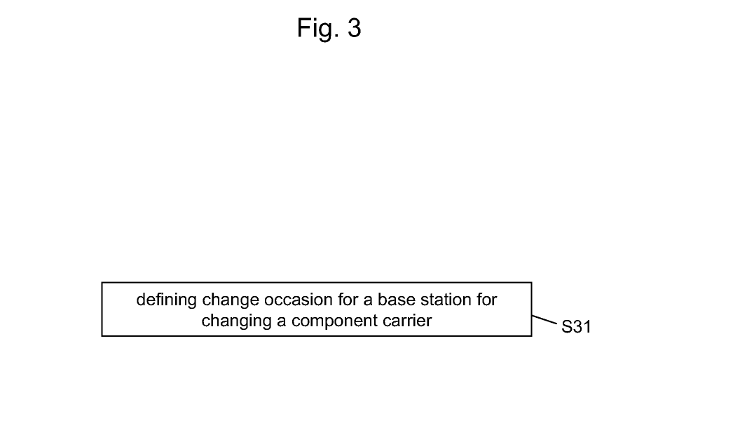

FIG. 3 is a flowchart illustrating an example of a method according to certain aspects of the first embodiment of the present invention. That is, as shown in FIG. 3, this method comprises defining, in a step S31, change occasion for a base station for changing a component carrier.

According to certain aspects of the first embodiment of the present invention, the method further comprises defining a second change occasion for a second base station, wherein the second change occasion for the second base station differs from the change occasion for the base station.

According to certain aspects of the first embodiment of the present invention, the change occasion includes a primary change occasion relating to change of a primary component carrier and a secondary change occasion relating to a change of a secondary component carrier.

According to certain aspects of the first embodiment of the present invention, the change occasion includes a cell state change occasion relating to change of the cell state from an active state to a dormant state or from a dormant state to an active state.

According to certain aspects of the first embodiment of the present invention, the definition of the change occasion includes at least one of periodicity, start offset and allowed number of carriers to change.

According to certain aspects of the first embodiment of the present invention, the change occasion is defined for a plurality of base stations and the start offset is different for each of the plurality of base stations.

According to certain aspects of the first embodiment of the present invention, the change occasion is defined with respect to a physical cell identifier and/or depending on load status of the base station.

According to certain aspects of the first embodiment of the present invention, an interval for the change occasion is adapted based on the load status of the small cell base station such that a higher load results in a shorter interval for the change occasion.

According to certain aspects of the first embodiment of the present invention, the method further comprises receiving configuration parameters regarding the definition of the change occasion from a controller, wherein the controller comprises a macro base station or the controller is located in a small cell base station.

According to certain aspects of the first embodiment of the present invention, the method is implemented by a macro base station or by a small cell base station.

According to certain aspects of the first embodiment of the present invention, the macro base station is located in a wireless network, such as LTE, LTE-A, GSM, GERAN, WCDMA, and the like.

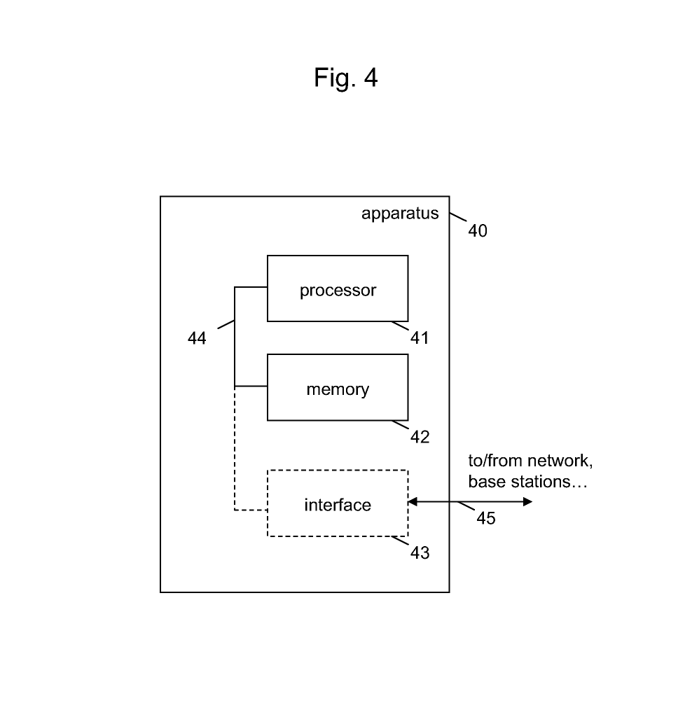

FIG. 4 is a block diagram illustrating an example of an apparatus according to certain aspects of the first embodiment of the present invention. The apparatus 40 comprises at least one processor 41 and at least one memory 42 including computer program code, which are connected by a bus 44 or the like. As indicated with a dashed line in FIG. 4, an interface 43 may optionally be connected to the bus 44 or the like, which may enable communication e.g. to/from a base station, user equipment, other network entity, or the like. The at least one memory and the computer program code are arranged to, with the at least one processor, cause the user equipment at least to perform defining change occasion for a base station for changing a component carrier.

For further functions of the apparatus, according to further exemplary aspects of the first embodiment of the present invention, reference is made to the above description of a method according to certain aspects of the first embodiments of the present invention, as described in connection with FIG. 3.

### Second Embodiment

### Scenario with X2 Interfaces

With the dense deployment of small cells in a local area (LA) network, there exists the scenario that there is common coverage with multiple pico cells. With different transmission power levels between pico eNBs and different cell range expansion (CRE) bias, the interference between pico cells becomes significant when these pico cells are rather close to each other. In this case, a pico UE that is located in the common coverage of two pico cells may suffer from the interference from adjacent pico eNBs severely.

With CA based ICIC solution, the control channel interference can not be avoided unless orthogonal carrier patterns are adopted at these adjacent pico eNBs respectively. That is, the pico cells' mutual interference severely affects the system performance and some coordination on carrier allocation between pico cell transmissions is required.

In CA based ICIC, the straightforward solution is that the aggressor cell, e.g., macro cell, shall notify the carrier pattern in carrier information, which applies to all the co-channel small cells for the addressed PDCCH protected carrier. It may be possible that the UEs in the common coverage of some adjacent pico cells can not use the same carrier pattern, since they are interfered severely by each other.

Consequently, one question arises how to apply different carrier patterns for them to ensure pico UEs in the common coverage can receive data reliably.

Moreover, one observation is whether a neighboring pico eNB 1 can allocate the carrier pattern for the pico eNB2, and whether pico eNB2 will know this carrier pattern is targeted at itself. Based on the approach mentioned in the introductory part, it can not be achieved. That means the neighboring pico eNB 2 can not have the knowledge of usable carrier free of interference allocated by pico eNB 1 to itself. Thus, how to allocate the appropriate carrier pattern in the scenario of dense small cell deployment becomes a critical point.

Therefore, according to the second embodiment of the present invention, the enhancement of CA based ICIC solution in a dense heterogeneous network (HetNet) with severely interfering small cells is proposed, to ensure the correct operation of carrier allocation solution when there exists severe common coverage for multiple small cells (i.e., multiple small cells are interfering each other severely).

In the following, as a specific example only, there is assumed a scenario with multiple small cells that are overlapping and under the coverage of the same macro eNB.

In the second embodiment, there is distinguished between a centralized coordination of carrier pattern under the control of the macro eNB and a distributed coordination of carrier pattern without the control of the macro eNB, which will be described in the following.

According to a first aspect of the second embodiment, it is proposed that a small cell eNB reports the carrier interference severeness with respect to the number of the UEs in the common coverage area of small cells as well as their traffic load to the macro eNB, and macro eNB determines the corresponding carrier patterns allocation towards different small cell eNBs. This is a centralized coordination of carrier pattern under the control of the macro eNB.

Thus, according to the first aspect, the small cells reflect the carrier interference severeness with respect to the number of the UE in the common coverage area of small cells as well as their traffic load by the UE to macro and based on it the macro eNB allocates the different carrier patterns, by adding the destination indication for a certain carrier pattern.

In some embodiments, there is defined the new parameter or information element (IE) of carrier interference severeness, which is used to indicate the carrier request for UEs in common coverage area between neighboring small cells.
Carrier interference severeness may be added in the IE ‘Invoke Indication’ or resources status information and piggybacked with the associated eNB ID with the common coverage as the source eNB ID.
Carrier interference severeness may be the expected PDCCH protected carrier number, and may be determined by the UE number and traffic load in the common coverage among neighboring cells.
Carrier interference severeness may include the associated eNB ID that is the interfered small cell eNB ID or the interfering eNB ID, and expects that there is different PDCCH protected carrier as that of source eNB in the allocated protecting resource by the macro eNB.

In some embodiments, there is defined the new parameter or IE of target eNB ID in the allocated carrier pattern information.
The target eNB ID indicated in carrier pattern information may be multiple considering the case that the small cells that are with the common coverage are perhaps more than 2 in a small cell enhanced network.
Allocated carrier pattern information can be composed of commonly usable PDCCH protected carrier and separately usable PDCCH protected carrier.
The separately usable PDCCH protected carrier is determined by the reflected carrier interference severeness.

According to a second aspect of the second embodiment of the present invention, it is proposed that a small cell eNB may allocate the carrier pattern to the other severely interfered small cell eNB, e.g., the neighboring small eNBs with the common coverage area. This is a distributed coordination of carrier pattern without the control of macro eNB.

According to the second aspect, the IE ‘Invoke Indication’ shall be targeted for different target eNBs, so that a small cell eNB is able to allocate the appropriate carrier pattern to the severely interfered neighboring cells.

In some embodiments, there is defined the new parameter or IE of target eNB ID in the IE ‘Invoke Indication’, which is used to indicate intended eNB that PDCCH protected carrier information is expected from.

In some embodiments, carrier interference severeness is added in the IE ‘Invoke Indication’ with the definite target eNB ID as neighboring aggressor small cell.

In some embodiments, an aggressor cell list is established and exchanged over inter eNB interface, together with the carrier interference severeness. The eNB in the aggressor cell list shall respond according to a predefined order, to avoid the simultaneous allocation/adjustment of the carrier pattern in order to speed the converging process.

Some example implementations for the second embodiment are described in the following.

As already indicated above, certain aspects of the second embodiment are applicable to a scenario with one macro eNB and multiple closely distributed pico cells, for example.

Further, the following basic IEs are involved according to certain aspects of the second embodiment:

Carrier information IE:
This IE provides information about which carriers the sending eNB is configuring as PDCCH protected carriers.
Macro can signal PDCCH protected carrier pattern to the pico nodes in carrier information IE.
A neighbouring macro-cell receiving this information may aim at using similar muting pattern.

Invoke information IE:
This IE provides an indication about which type of information the sending eNB would like the receiving eNB to send back.
Can be used by pico nodes to suggest macro eNB to use a certain muting pattern. Can also be sent between pico eNBs.

Both the carrier information IE and/or Invoke information IE are/is part of the LOAD INFORMATION message.

According to the first aspect of the second embodiment, the pico eNB shall initiate and send invoke indication that includes carrier interference severeness to macro eNB, to request protected resources.
The carrier interference severeness contains the expected separately usable PDCCH protected carrier number and associated pico eNB ID with some common coverage as the initiating pico eNB.
The mutual carrier interference severeness between pico eNBs can be based on the RSRP/RSRQ report from the served pico UE.
Based on it, the number of such UEs located within the common coverage of two pico eNBs as well as their traffic load may be used to derive the expected different PDCCH protected carrier number.

Further, the macro eNB shall notify the allocated carrier information to the corresponding pico eNB with target eNB ID.

The pico eNB who is the proposed target eNB shall transmit in the allocated different/separate PDCCH protected carriers for the interfered UE that require such resource for data protection.
Transmit to interfered pico UE located in the common coverage area in the separately usable PDCCH protected carrier resource with the corresponding closely located pico eNB,
Transmit to interfered pico UE located out of the common coverage in the commonly usable PDCCH protected carrier resource with the corresponding closely located pico eNB,

The associated pico eNB, no matter the interfered one or the interfering one, shall
Transmit to interfered pico UE located in the common coverage in the separately usable PDCCH protected carrier resource with the corresponding closely located pico eNB,
Transmit to interfered pico UE located out of the common coverage in the commonly usable PDCCH protected carrier resource with the corresponding closely located pico eNB,
Mute their transmission for UE in CRE in the separately usable PDCCH protected carrier that does not belong to the usable PDCCH protected carrier to itself, to guarantee the interference is acceptable within some given carrier (i.e., the separately usable PDCCH protected carrier).

Other pico eNB who is neither the proposed target eNB nor the associated pico eNB shall transmit normally in the allocated protecting resource for itself.

According to the second aspect of the second embodiment, the victim eNB, e.g., pico eNB 1, shall initiate and send invoke indication that includes the carrier interference severeness to the neighboring intended pico eNB 2, to request protected resource.
The carrier interference severeness contains only the expected separately usable PDCCH protected carrier number.
The mutual carrier interference severeness between pico eNBs can be based on the RSRP/RSRQ report from the served pico UE.
Based on it, the number of such UEs located in the common coverage of two pico eNBs as well as their DL traffic load may be used to derive the expected separately usable PDCCH protected carrier number.

The intended pico eNB 2 shall notify the allocated carrier information to the initiated pico eNB.
The allocated carrier information should be a subset of that by the macro eNB.
Otherwise, it should send the request for the macro eNB to request further on the protected resource.
The finally allocated carrier information shall be indicated to macro eNB.

The pico eNB 1 who is the proposed target eNB shall transmit in the newly allocated PDCCH protected carrier by pico eNB 2 for the interfered pico UE located in the common coverage.

The pico eNB who is not the proposed target eNB shall transmit normally in the allocated PDCCH protected carrier resource allocated by macro eNB for the interfered pico UE.

When there are multiple adjacent interfering pico eNBs, usually a victim eNB shall initiate the Invoke Indication.

The eNB in the aggressor cell list shall respond according to a pre-defined order, to avoid the simultaneous allocation/adjustment of the carrier pattern in order to speed the converging process.

The adjustment is semi-static, which could become applicable although taking time for convergence for some specific cases.

According to the second embodiment, the IEs ‘carrier information’ and ‘invoke indication’, as described in document [4] are modified, for example, as shown in the following (newly added items are indicated using bold italic font).

The IE ‘Carrier Information’ provides information about which carriers the sending eNB is configuring as PDCCH protected carriers. PDCCH protected carriers are carriers with reduced power on some physical channels and/or reduced activity.

| | | | IE type and | |
|---|---|---|---|---|
| IE/Group Name | Presence | Range | reference | Semantics description |
| CHOICE Carrier | M | | — | — |
| Information | | | | |
| >Target Cell ID | M | | ECGI | Id of the cell for which |
| | | | 9.2.14 | the carrier information |
| | | | | is meant |
| >Carrier pattern Info | M | | BIT STRING | Each position in the |
| | | | (SIZE(40)) | bitmap represents a |
| | | | | carrier, for which value |
| | | | | “1” indicates ‘blanked in |
| | | | | PDCCH’ and value “0” |
| | | | | indicates ‘not blanked in |
| | | | | PDCCH’. |
| >CA based ICIC Inactive | M | | NULL | Indicates that |
| | | | | interference coordination |
| | | | | by means of PDCCH |
| | | | | protected carrier is not |
| | | | | active |

The IE ‘Invoke Indication’ provides an indication about which type of information the sending eNB would like the receiving eNB to send back.

| | | | IE type and | |
|---|---|---|---|---|
| IE/Group Name | Presence | Range | reference | Semantics description |
| Invoke Indication | M | | ENUMERATED | — |
| | | | (ABS | |
| | | | Information, . . . ) | |
| >Target Cell ID | M | | ECGI | Id of the cell for which |
| | | | 9.2.14 | the invoke indication is |
| | | | | meant |
| >carrier | O | | | |
| interference | | | | |
| severeness | | | | |
| >>The expected | O | | | It can be derived based |
| PDCCH protected | | | | on UE report of |
| carriers number | | | | RSRP/RSRQ. The UE |
| | | | | number and DL traffic |
| | | | | load of such UE in the |
| | | | | common coverage |
| | | | | among neighboring |
| | | | | cells will directly |
| | | | | determine the expected |
| | | | | number of PDCCH |
| | | | | protected carriers. |
| >>The associated | O | | | The associated eNB |
| interfered/interfering | | | | expects that there is |
| eNB ID | | | | different PDCCH |
| | | | | protected carriers |
| | | | | resource as that of |
| | | | | source eNB in the |
| | | | | allocated protecting |
| | | | | resource. |
| >>Aggressor cell | O | | | The eNB in the |
| list | | | | aggressor cell list |
| | | | | shall respond |
| | | | | according to a |
| | | | | predefind order. |
| | | | | The predefined |
| | | | | order could be in |
| | | | | terms of some |
| | | | | offsets, to avoid the |
| | | | | simultaneous |
| | | | | allocation/adjustment |
| | | | | of the carrier |
| | | | | pattern in order to |
| | | | | speed the |
| | | | | converging process. |

According to certain aspects of the second embodiment of the present invention, the following advantages are achieved.

The proposed enhancement of reflecting on carrier interference severeness and specific carrier pattern allocation effectively avoids the carrier interference between two neighboring pico cells that are with large common coverage and interfering each other severely.

The proposed enhancement of Invoke Indication enables an aggressor pico cell to allocate the appropriate carrier pattern to the victim pico cells that are with large common coverage and interfered severely.

The central solution according to certain aspects of the second embodiment reduces some confusion among small cell eNBs for some specific cases.

The distributed solution according to certain aspects of the second embodiment requires some coverage algorithm to get the consistent allocation among each other which may cause additional overhead and latency for the final carrier adjustment.

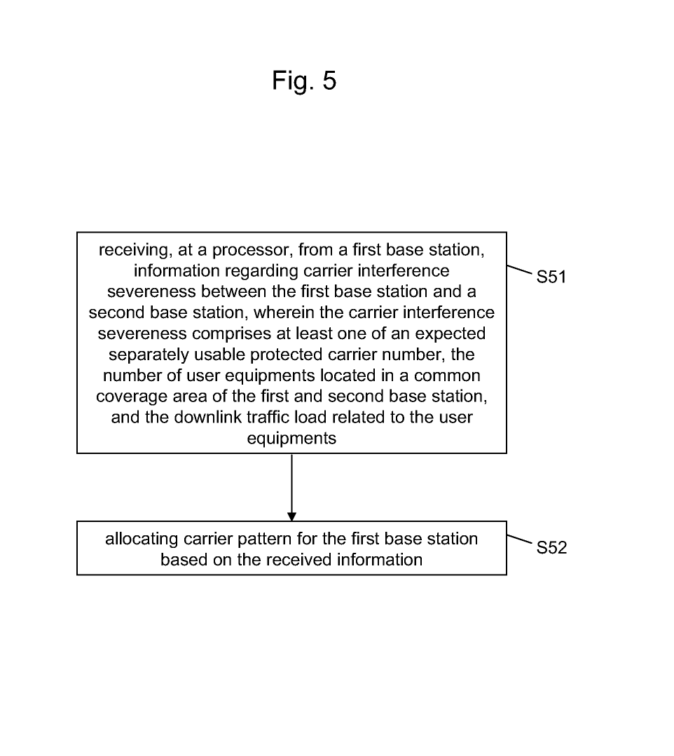

FIG. 5 is a flowchart illustrating an example of a method according to certain aspects of the second embodiment of the present invention. That is, as shown in FIG. 5, this method comprises receiving, at a processor in a step S51, from a first base station, information regarding carrier interference severeness between the first base station and a second base station, wherein the carrier interference severeness comprises at least one of an expected separately usable protected carrier number, the number of user equipments located in a common coverage area of the first and second base station, and the downlink traffic load related to the user equipments, and allocating carrier pattern for the first base station based on the received information in a step S52.

According to certain aspects of the second embodiment of the present invention, the processor locates in a third base station, and the carrier interference severeness comprises at least one of the number of user equipments located in a common coverage area of the first and second base station, and the downlink traffic load related to the user equipments.

According to certain aspects of the second embodiment of the present invention, the carrier pattern is allocated by adding a destination indication relating to a respective one of the first and second base stations for a certain carrier pattern.

According to certain aspects of the second embodiment of the present invention, the carrier interference severeness indicates a carrier request for user equipments in the common coverage area of the first and second base stations.

According to certain aspects of the second embodiment of the present invention, the carrier interference severeness includes at least one of an expected protected carrier number and an identification of a cell corresponding to the first or second base station.

According to certain aspects of the second embodiment of the present invention, the carrier interference severeness is derived based on reference signal receiving power and/or a reference signal receiving quality reported by the user equipment.

According to certain aspects of the second embodiment of the present invention, the carrier interference severeness includes an associated base station identification that is an identification of an interfered base station or an identification of an interfering base station, wherein a protected carrier allocated by the first base station to the associated based station is different from a protected carrier of a source base station.

According to certain aspects of the second embodiment of the present invention, the source base station is the first base station and the associated base station is the second base station.

According to certain aspects of the second embodiment of the present invention, allocated carrier pattern information is composed of commonly usable protected carrier and separately usable protected carrier.

According to certain aspects of the second embodiment of the present invention, the separately usable protected carrier is determined by the reflected carrier interference severeness.

According to certain aspects of the second embodiment of the present invention, the requested number of expected separately usable protected carrier is determined by determination factors including the number of user equipment or active user equipment in the common coverage area of the first and second base stations as well as the downlink traffic load of the user equipment or active user equipment.

According to certain aspects of the second embodiment of the present invention, active user equipment denotes the user equipment that requires the service or is in a connected state.

According to certain aspects of the second embodiment of the present invention, the carrier interference severeness is a direct reflector of expected number of protected carrier or the determination factors.

According to certain aspects of the second embodiment of the present invention, the first and second base station are small cell base stations and the third base station is a macro base station.

According to certain aspects of the second embodiment of the present invention, the processor is part of the third base station located in any one of a wireless network, such as LTE, LTE-A, GSM, GERAN, WCDMA, and the like.

According to certain aspects of the second embodiment of the present invention, the processor locates in the second base station, and the carrier interference severeness comprises of an expected separately usable protected carrier number.

According to certain aspects of the second embodiment of the present invention, an invoke indication is sent by adding the first base station as a destination indication from which the protected carrier is expected.

According to certain aspects of the second embodiment of the present invention, the carrier interference severeness is sent by adding the first base station as a destination indication.

According to certain aspects of the second embodiment of the present invention, the expected separately usable protected carrier number is derived based on the number of user equipment located in the common coverage area of the first and second base station and the traffic load of the user equipment.

According to certain aspects of the second embodiment of the present invention, the carrier interference severeness is derived based on reference signal receiving power and/or a reference signal receiving quality reported by a user equipment located in the common coverage area of the first and second base station.

According to certain aspects of the second embodiment of the present invention, an aggressor cell list is established and piggybacked with carrier interference severeness to be exchanged over inter base station interface.

According to certain aspects of the second embodiment of the present invention, a base station in the aggressor cell list responds according to a predefined order to avoid the simultaneous allocation/adjustment of carrier pattern.

According to certain aspects of the second embodiment of the present invention, the first and the second base station are small cell base stations.

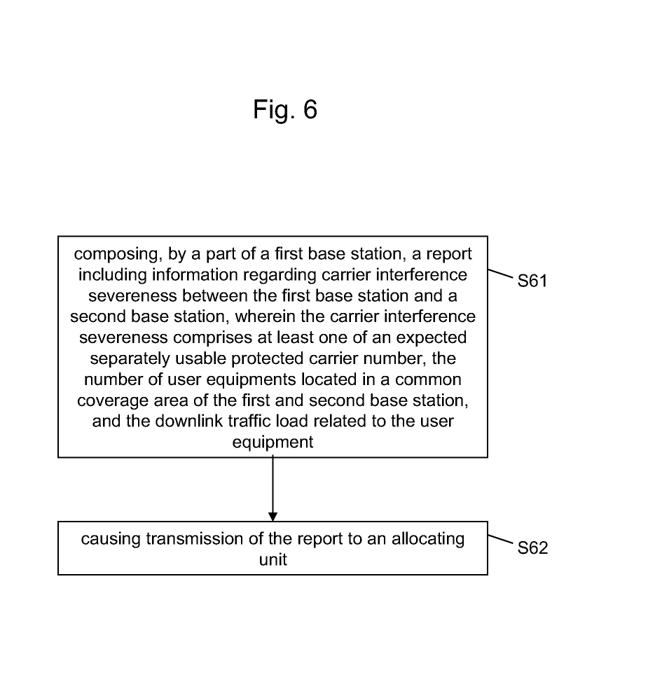

FIG. 6 is a flowchart illustrating an example of a method according to certain aspects of the second embodiment of the present invention. That is, as shown in FIG. 6, this method comprises composing, for example by a first network node (e.g. a first base station) or by part of a first network node (e.g. a first base station), in a step S61, a report including information regarding carrier interference severeness between the first base station and a second base station, wherein the carrier interference severeness comprises at least one of an expected separately usable protected carrier number, the number of user equipments located in a common coverage area of the first and second base station, and the downlink traffic load related to the user equipment, and causing transmission of the report to an allocating unit in a step S62.

According to certain aspects of the second embodiment of the present invention, the allocating unit is located in a third base station, and the carrier interference severeness comprises at least one of the number of user equipments located in a common coverage area of the first and second base station, and the downlink traffic load related to the user equipments.

According to certain aspects of the second embodiment of the present invention, the method further comprises receiving, at the first base station, an allocation of carrier pattern from the third base station.

According to certain aspects of the second embodiment of the present invention, the first and the second base station are small cell base stations and the third base station is a macro base station. The macro base station is located in any one of a wireless network, such as LTE, LTE-A, GSM, GERAN, WCDMA, and the like.

According to certain aspects of the second embodiment of the present invention, the allocating unit is located in the second base station, and the carrier interference severeness comprises of an expected separately usable protected carrier number.

According to certain aspects of the second embodiment of the present invention, the method further comprises receiving, at the first base station, an allocation of carrier pattern from the second base station.

According to certain aspects of the second embodiment of the present invention, the first and the second base station are small cell base stations.

According to certain aspects of the second embodiment of the present invention, the method is implemented by the network node or base station or by a part of the network node or part of the base station.

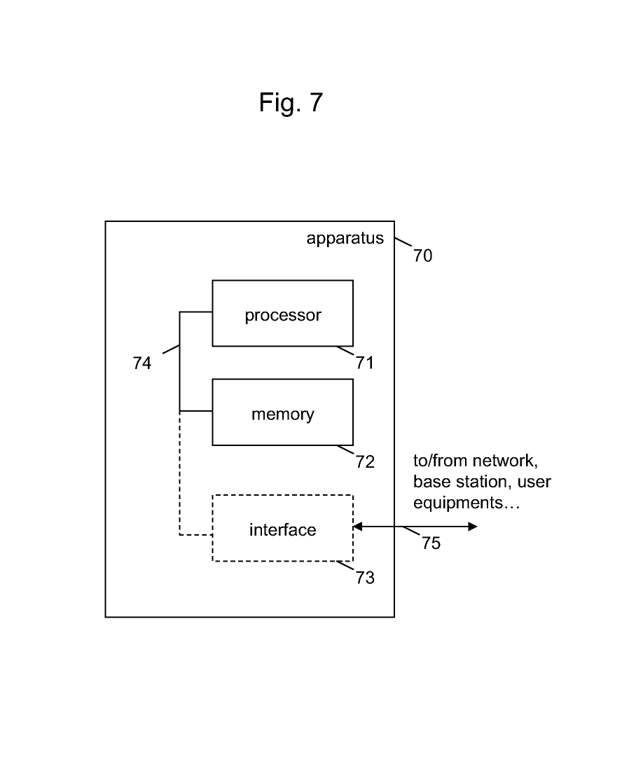

FIG. 7 is a block diagram illustrating an example of an apparatus according to certain aspects of the second embodiment of the present invention. As described above, the apparatus 70 comprises at least one processor 71 and at least one memory 72 including computer program code, which are connected by a bus 74 or the like. As indicated with a dashed line in FIG. 7, an interface 73 may optionally be connected to the bus 74 or the like, which may enable communication e.g. to/from another base station, user equipment, other network entity, or the like.

According to certain aspects of the second embodiment of the present invention, the at least one memory and the computer program code are arranged to, with the at least one processor, cause the apparatus at least to perform receiving, from a first base station, information regarding carrier interference severeness between the first base station and a second base station, wherein the carrier interference severeness comprises at least one of an expected separately usable protected carrier number, the number of user equipments located in a common coverage area of the first and second base station, and the downlink traffic load related to the user equipments, and allocating carrier pattern for the first base station based on the received information.

Further, the apparatus is part of a first base station and the at least one memory and the computer program code are arranged to, with the at least one processor, cause the apparatus at least to perform composing a report including information regarding carrier interference severeness between the first base station and a second base station, wherein the carrier interference severeness comprises at least one of an expected separately usable protected carrier number, the number of user equipments located in a common coverage area of the first and second base station, and the downlink traffic load related to the user equipment, and causing transmission of the report to an allocating unit.

For further functions of the base station, according to further exemplary aspects of the second embodiment of the present invention, reference is made to the above description of methods according to certain aspects of the second embodiments of the present invention, as described in connection with FIGS. 5 and 6.

In the foregoing exemplary description of the apparatuses, i.e. the base station (or part of the base station), only the units that are relevant for understanding the principles of the invention have been described using functional blocks. The apparatuses may comprise further units that are necessary for its respective operation as base station or part of the base station, respectively. However, a description of these units is omitted in this specification. The arrangement of the functional blocks of the apparatuses is not construed to limit the invention, and the functions may be performed by one block or further split into sub-blocks.

According to exemplarily embodiments of the present invention, a system may comprise any conceivable combination of the thus depicted devices/apparatuses and other network elements, which are arranged to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any procedural step or functionality is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, system in package (SIP), or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

Even though the present invention and/or exemplary embodiments are described above with reference to the examples according to the accompanying drawings, it is to be understood that they are not restricted thereto. Rather, it is apparent to those skilled in the art that the present invention can be modified in many ways without departing from the scope of the inventive idea as disclosed herein.

### ABBREVIATIONS

CA Carrier Aggregation

CB-ICIC Carrier-based Inter-Cell Interference Coordination

CC Component Carrier

CE Control Element

CQI Channel Quality Indicator

CRE Cell Range Expansion

CSI Channel Status Information

DL Downlink

EDGE Enhanced Data Rates for GSM Evolution

eNB Enhanced Node B

GERAN GSM EDGE Radio Access Network

GSM Global System for Mobile Communication

HO HandOver

ICIC Inter-Cell Interference Coordination

LA Local Area

LTE Long Term Evolution

LTE-A Long Term Evolution Advanced

MAC Medium Access Control

OCS Operational carrier selection

PCC Primary Component Carrier

Rx Receive

RRC Radio Resource Control

RSRP Reference Signal Receiving Power

RSRQ Reference Signal Receiving Quality

SCC Secondary Component Carrier

Tx Transmit

UE User Equipment

UL Uplink

1-10. (canceled)

11. A method, comprising:
receiving, at a processor, from a first base station, information regarding carrier interference severeness between the first base station and a second base station,
wherein the carrier interference severeness comprises at least one of an expected separately usable protected carrier number, the number of user equipments located in a common coverage area of the first and second base station, and the downlink traffic load related to the user equipments, and
allocating carrier pattern for the first base station based on the received information.

12. A method according to claim 11, wherein
the processor locates in a third base station, and
the carrier interference severeness comprises at least one of the number of user equipments located in a common coverage area of the first and second base station, and the downlink traffic load related to the user equipments.

13. The method according to claim 12, wherein
the carrier pattern is allocated by adding a destination indication relating to a respective one of the first and second base stations for a certain carrier pattern.

14. The method according to claim 12, wherein
the carrier interference severeness indicates a carrier request for user equipments in the common coverage area of the first and second base stations.

15. The method according to claim 12, wherein
the carrier interference severeness includes at least one of an expected protected carrier number and an identification of a cell corresponding to the first or second base station.

16. The method according to claim 12, wherein
the carrier interference severeness is derived based on reference signal receiving power and/or a reference signal receiving quality reported by the user equipment.

17. The method according to claim 12, wherein
the carrier interference severeness includes an associated base station identification that is an identification of an interfered base station or an identification of an interfering base station, wherein a protected carrier allocated by the first base station to the associated based station is different from a protected carrier of a source base station.

18. The method according to claim 17, wherein
the source base station is the first base station and the associated base station is the second base station.

19. The method according to claim 12, wherein
allocated carrier pattern information is composed of commonly usable protected carrier and separately usable protected carrier.

20. The method according to claim 12, wherein
the separately usable protected carrier is determined by the reflected carrier interference severeness.

21-40. (canceled)

41. An apparatus, comprising:
at least one processor,
and at least one memory including computer program code,
the at least one memory and the computer program code arranged to, with the at least one processor, cause the apparatus at least to perform:
defining change occasion for a base station for changing a component carrier.

42. The apparatus according to claim 41, wherein the at least one memory and the computer program code are further arranged to, with the at least one processor, cause the apparatus at least to perform
defining a second change occasion for a second base station, wherein the second change occasion for the second base station differs from the change occasion for the base station.

43. The apparatus according to claim 41, wherein
the change occasion includes a primary change occasion relating to change of a primary component carrier and a secondary change occasion relating to a change of a secondary component carrier.

44. The apparatus according to claim 41, wherein
the change occasion includes a cell state change occasion relating to change of the cell state from an active state to a dormant state or from a dormant state to an active state.

45. The apparatus according to claim 41, wherein
the definition of the change occasion includes at least one of periodicity, start offset and allowed number of carriers to change.

46. The apparatus according to claim 45, wherein
the change occasion is defined for a plurality of base stations and the start offset is different for each of the plurality of base stations.

47-50. (canceled)

51. An apparatus, comprising:
at least one processor,
and at least one memory including computer program code,
the at least one memory and the computer program code arranged to, with the at least one processor, cause the apparatus at least to perform:
receiving, from a first base station, information regarding carrier interference severeness between the first base station and a second base station, wherein the carrier interference severeness comprises at least one of an expected separately usable protected carrier number, the number of user equipments located in a common coverage area of the first and second base station, and the downlink traffic load related to the user equipments, and
allocating carrier pattern for the first base station based on the received information.

52. The apparatus according to claim 51, wherein
the apparatus is part of a third base station, and
the carrier interference severeness comprises at least one of the number of user equipments located in a common coverage area of the first and second base station, and the downlink traffic load related to the user equipments.

53. The apparatus according to claim 52, wherein
the carrier pattern is allocated by adding a destination indication relating to a respective one of the first and second base stations for a certain carrier pattern.

54. The apparatus according to claim 52, wherein
the carrier interference severeness indicates a carrier request for user equipments in the common coverage area of the first and second base stations.

55-87. (canceled)
